(19) United States
(12) Patent Application Publication
(10) Pub. No.: US 2022/0025226 A1
(43) Pub. Date: Jan. 27, 2022

(54) Adhesive Sheet, Laminate Sheet, and Image Display Device Technical Field

(71) Applicant: Mitsubishi Chemical Corporation, Tokyo (JP)

(72) Inventor: Daiki Tabata, Tokyo (JP)

(73) Assignee: Mitsubishi Chemical Corporation, Tokyo (JP)

(21) Appl. No.: 17/479,123

(22) Filed: Sep. 20, 2021

Related U.S. Application Data
(63) Continuation of application No. PCT/JP2020/013955, filed on Mar. 27, 2020.

(30) Foreign Application Priority Data
Mar. 29, 2019 (JP) 2019-065470

(51) Int. Cl. C09J 133/12; C09J 7/30; B32B 7/022; B32B 7/12; B32B 27/08; C09J 175/14

(52) U.S. Cl. CPC C09J 133/12; C09J 7/30; B32B 7/022; B32B 7/12; B32B 2307/54; C09J 175/14; B32B 2457/208; B32B 2307/51; B32B 27/08

(57) ABSTRACT

Provided is an adhesive sheet causing neither cracks nor delamination when bonding to a member sheet to form a laminate sheet even when the laminate sheet is folded under low and high temperature environments, and having excellent restorability when the laminate sheet is bent and held under high temperature conditions.

Proposed is an adhesive sheet satisfying the following requirements (1) to (3):
(1) the storage shear elastic modulus at 80° C. (G′(80° C.)) obtained by dynamic viscoelasticity measurement in a shear mode at a frequency of 1 Hz is 1.0 kPa or more and 100 kPa or less;
(2) the storage shear elastic modulus at −20° C. (G′(−20° C.)) obtained by dynamic viscoelasticity measurement in a shear mode at a frequency of 1 Hz is 1.0 kPa or more and 140 kPa or less; and
(3) when the storage shear elastic modulus is measured by dynamic viscoelasticity measurement in a shear mode at a frequency of 1 Hz, the average slope of −20° C. to 80° C., which is represented by formula (1): average slope=(G′(80° C.)−G′(−20° C.))/100, is −0.40 to 0 (kPa/° C.) on a graph where the y-axis represents the storage shear elastic modulus (kPa) and the x-axis represents the temperature (° C.).

### TECHNICAL FIELD

The present invention relates to an adhesive sheet, a laminate sheet, and an image display device.

### BACKGROUND ART

In recent years, image display devices with curved surfaces and foldable image display devices using organic light emitting diodes (OLEDs) and quantum dots (QDs) have been developed and are being widely commercialized.

Such display devices have a laminated structure in which a cover lens, a circular polarizing plate, a touch film sensor, a light emitting element, and the like (these members are also referred to as “member sheets”) are bonded together with transparent adhesive sheets, and can be constituted of a plurality of laminate sheets formed by laminating member sheets and adhesive sheets.

As the laminate sheets used for foldable image display devices, for example, Patent Document 1 discloses an optical device member for flexible displays having a first adhesive film, a touch function member, and a second adhesive film, wherein the first adhesive film or the second adhesive film has a storage shear elastic modulus at 80° C. of 10 to 140 kPa, and an average slope of the storage shear elastic moduluses at −20° C. to 80° C. of −9.9 to 0 kPa/° C.; and also describes the range of suitable viscoelasticity.

### CITATION LIST

### Patent Document

Patent Document 1: US2016/0122599 A1

### SUMMARY OF THE INVENTION

### Problem to be Solved by the Invention

The multi-layer sheet constituting the foldable image display device has various problems due to interlayer stress during bending. For example, peeling may occur between layers when folded, and there has been a demand for a laminate sheet that does not peel even when folded. There has also been a demand for a laminate sheet that can be quickly restored to a flat state when the screen is opened from the folded state. In addition, as the folding operation is repeated, the member sheet, which is an adherend, may crack and eventually break, and there has been a demand for a laminate sheet having durability under repeated folding operations, especially at low temperatures.

However, in the adhesive sheet disclosed in Patent Document 1, for example, the adhesive sheet described in Examples thereof, the amount of distortion of the adhesive sheet increases depending on the radius of curvature at the time of folding, which may cause problems such as a phenomenon in which the layers are peeled off after bonding (referred to as “delamination”).

The thickness of the image display device and its constituent members has become thinner and thinner in recent years, and there has also been a problem that the adherend to which the adhesive sheet is bonded is cracked due to the interlayer stress by folding.

Thus, the present invention is intended to provide an adhesive sheet and a laminate sheet causing neither cracks nor delamination when the adhesive sheet is bonded to a member sheet to form a laminate sheet even when the laminate sheet is folded under low and high temperature environments. The present invention is also intended to provide an adhesive sheet and a laminate sheet having no temperature dependency, and excellent restorability when the laminate sheet is bent and held under high temperature conditions.

### Means for Solving Problem

The present invention proposes an adhesive sheet satisfying the following requirements (1) to (3):

(1) the storage shear elastic modulus at 80° C. (G′(80° C.)) obtained by dynamic viscoelasticity measurement in a shear mode at a frequency of 1 Hz is 1.0 kPa or more and 100 kPa or less;

(2) the storage shear elastic modulus at −20° C. (G′(−20° C.)) obtained by dynamic viscoelasticity measurement in a shear mode at a frequency of 1 Hz is 1.0 kPa or more and 140 kPa or less; and

(3) when the storage shear elastic modulus is measured by dynamic viscoelasticity measurement in a shear mode at a frequency of 1 Hz, the average slope of −20° C. to 80° C., which is represented by the following formula (1), is −0.40 to 0 (kPa/° C.) on a graph where the y-axis represents the storage shear elastic modulus (kPa) and the x-axis represents the temperature (° C.).

Average slope=(G′(80° C.)−G′(−20° C.))/100 (1)

The present invention also proposes a laminate sheet having a structure in which the adhesive sheet and a member sheet are laminated.

The member sheet is preferably a member sheet having a tensile strength at 25° C., as measured according to ASTM D882, of 10 to 900 MPa (also referred to as “first member sheet”).

### Effect of the Invention

The adhesive sheet proposed by the present invention reduces the stress applied to the member sheet when bonding to the member sheet to form a laminate sheet, and prevents delamination and cracking of the laminate sheet even when the laminate sheet is folded under low and high temperature environments. In addition, the laminate sheet has excellent restorability when being bent and held under high temperature conditions.

Accordingly, the adhesive sheet proposed by the present invention and the laminate sheet using the adhesive sheet can be suitably used as a constituent member of a foldable image display device or the like.

### MODE(S) FOR CARRYING OUT THE INVENTION

Next, the present invention will be described based on exemplary embodiments. However, the present invention is not limited to the embodiments that will be described below.

[Present Adhesive Sheet]

The adhesive sheet according to an example of the embodiment of the present invention (hereinafter, may be referred to as “present adhesive sheet”) is an adhesive sheet satisfying the following requirements (1) to (3):

(1) the storage shear elastic modulus at 80° C. (G′(80° C.)) obtained by dynamic viscoelasticity measurement in a shear mode at a frequency of 1 Hz is 1 kPa or more and 100 kPa or less;

(2) the storage shear elastic modulus at −20° C. (G′(−20° C.)) obtained by dynamic viscoelasticity measurement in a shear mode at a frequency of 1 Hz is 1 kPa or more and 140 kPa or less; and

(3) when the storage shear elastic modulus is measured by dynamic viscoelasticity measurement in a shear mode at a frequency of 1 Hz, the average slope of −20° C. to 80° C., which is represented by the following formula (1), is −0.40 to 0 (kPa/° C.) on a graph where the y-axis represents the storage shear elastic modulus (kPa) and the x-axis represents the temperature (° C.).

Average slope=(G′(80° C.)−G′(−20° C.))/100 (1)

The laminate sheet according to an example of the embodiment of the present invention (hereinafter, may be referred to as “present laminate sheet”) is a laminate sheet having a structure in which a member sheet satisfying the following requirement (4) (referred to as “first member sheet”) and the present adhesive sheet are laminated:

(4) the tensile strength at 25° C., as measured according to ASTM D882, is 10 to 900 MPa.

First, the present adhesive sheet constituting the present laminate sheet will be described.

<Storage Shear Elastic Modulus and Loss Tangent>

The present adhesive sheet preferably has a storage shear elastic modulus at 80° C. (G′(80° C.)) of 1 kPa or more and 100 kPa or less, which is obtained by dynamic viscoelasticity measurement in a shear mode at a frequency of 1 Hz.

The storage shear elastic modulus at 80° C. (G′(80° C.)) of the present adhesive sheet is preferably 1 kPa or more and 100 kPa or less, more preferably 2 kPa or more or 90 kPa or less, and even more preferably 3 kPa or more or 80 kPa or less.

By setting the storage shear elastic modulus (G′(80° C.)) in the above range, for example, when the present adhesive sheet is bonded to a member sheet to form a laminate sheet, the interlayer stress during bending the laminate sheet can be reduced at room temperature to high temperature, thereby suppressing delamination and cracking of the member sheet.

The present adhesive sheet preferably has a loss tangent at 80° C. (tan δ (80° C.)) of 0.60 or less in a shear measurement at a frequency of 1 Hz. It is more preferably 0.50 or less, and even more preferably 0.40 or less. By setting the loss tangent (tan δ (80° C.)) in the above range, the flow of the adhesive sheet can be suppressed, and for example, when the present adhesive sheet is bonded to a member sheet to form a laminate sheet, the laminate sheet can have good restorability when being opened from the folded state.

To reduce both the storage shear elastic modulus (G′ (80° C.)) and the loss tangent (tan δ (80° C.)), the molecular weight between the crosslinking points may be increased to increase the gel component. To increase the molecular weight between the crosslinking points in the adhesive sheet, the number of polyfunctional monomers may be reduced, or a high molecular weight crosslinking agent may be used. However, it is not limited to these methods.

In addition, to reduce the loss tangent (tan δ (80° C.)), the uncrosslinked or unreacted components in the present adhesive sheet may be reduced. However, it is not limited to these methods.

Even if the storage shear elastic modulus (G′(80° C.)) of the present adhesive sheet is 100 kPa or less, the present adhesive sheet may undergoes creep deformation during high temperature bending when the loss tangent (tan δ (80° C.)) is large. However, by setting the loss tangent (tan δ (80° C.)) to 0.60 or less, the creep deformation can be suppressed, and the restorability when being opened from the folded state can be improved.

The present adhesive sheet preferably has a storage shear elastic modulus at −20° C. (G′(−20° C.)) of 1 kPa or more and 140 kPa or less, which is obtained by dynamic viscoelasticity measurement in a shear mode at a frequency of 1 Hz. Above all, it is more preferably 1 kPa or more or 139 kPa or less. By setting the storage shear elastic modulus (G′(−20° C.)) of the adhesive sheet to 140 kPa or less, the interlayer stress during bending can be reduced at low temperature, thereby suppressing delamination and cracking of the member sheet.

In general, the storage shear elastic modulus (G′(−20° C.)) is larger than the storage shear elastic modulus (G′(80° C.)) since the adhesive sheet has a glass transition temperature (Tg) between low temperature and room temperature. However, when the storage shear elastic modulus (G′(−20° C.)) is 140 kPa or less, cracking of the member sheet can be prevented even if the bending operation is performed at low temperatures.

The thickness of the member sheet becomes thinner and thinner in recent years, and thus it is important to reduce the stress on the member sheet.

Examples of the member sheet to which the present adhesive sheet is bonded, which is the one to be used as a member sheet for the image display device, include a sheet made of polyimide, polyester, TAC, or cyclic olefin.

Among them, the tensile strength at 25° C. of the cyclic olefin polymer is as low as 40 to 60 MPa at 100 μm. In the case of a laminate sheet using a member sheet having such a low tensile strength, cracking tends to occur during bending, and it has been difficult to eliminate the cracking within the scope of the prior art.

Thus, by reducing the average slope of the storage elastic moduluses of −20° C. to 80° C. in the adhesive sheet, the interlayer stress generated when the adhesive sheet is bonded to the member sheet and bent at low temperatures can be reduced, and as a result, cracking of the member sheet can be suppressed.

Here, the average slope (kPa/° C.) is represented by the following formula (1).

Average slope=(G′(80° C.)−G′(−20° C.))/100 (1)

In addition, in the case where the adhesive sheet has a small average slope of the storage elastic moduluses of −20° C. to 80° C. and satisfies a loss tangent (tan δ (80° C.)) of 0.60 or less, foaming can be suppressed when the laminate sheet is exposed to high temperature and humidity.

[Maximum Point of Loss Tangent (tan δ) and Glass Transition Temperature (Tg)]

The present adhesive sheet preferably has a maximum point of a loss tangent obtained by dynamic viscoelasticity measurement in a shear mode at a frequency of 1 Hz of −25° C. or less.

The maximum point of the loss tangent (tan δ) can be interpreted as the glass transition temperature (Tg), and when the glass transition temperature (Tg) is in the above range, the storage shear elastic modulus (G′(−20° C.)) of the present adhesive sheet can be easily adjusted to 140 kPa or less.

Here, the term “glass transition temperature” refers to the temperature at which the peak of the main dispersion of the loss tangent (tan δ) appears. Therefore, when only one maximum point of the loss tangent (tan δ) obtained by dynamic viscoelasticity measurement in a shear mode at a frequency of 1 Hz is observed, in other words, when the tan 5 curve exhibits a single peak shape, the glass transition temperature (Tg) can be considered to be single.

The term “maximum point” of the loss tangent (tan δ) means the peak value in the tan 5 curve, that is, the point having the maximum value in a predetermined range or the entire range among the inflection points that change from positive (+) to negative (−) when differentiated.

The elastic modulus (storage elastic modulus) G′, the viscosity (loss elastic modulus) G″, and tan δ=G″/G′ at various temperatures can be measured using a strain rheometer.

<Relative Permittivity>

The present adhesive sheet preferably has a relative permittivity of 5.0 or less.

When the relative permittivity of the present adhesive sheet is 5.0 or less, malfunctions of the touch panel can be reduced when the present adhesive sheet is used, for example, as a member on the lower side of the touch panel.

From such a viewpoint, the relative permittivity of the present adhesive sheet is preferably 5.0 or less, more preferably 2.0 or more or 4.5 or less, and even more preferably 2.5 or more or 4.0 or less.

As a method of adjusting the relative permittivity of the present adhesive sheet, for example, the relative permittivity can be adjusted within the above range by adding a polyolefin-based adhesive, a silicone-based adhesive, or the like. The relative permittivity can be lowered by selecting a (meth) acrylate having an alkyl group with 9 to 22 carbon atoms as the monomer component for the acrylic polymer constituting the present adhesive sheet. However, it is not limited to this method.

<Total Light Transmittance and Haze>

The present adhesive sheet preferably has a total light transmittance of 85% or more, more preferably 88% or more, and even more preferably 90% or more.

The present adhesive sheet preferably has a haze of 1.0% or less, more preferably 0.8% or less, and particularly preferably 0.5% or less.

When the haze of the present adhesive sheet is 1.0% or less, the present adhesive sheet can be used in applications for image display devices. To adjust the haze of the present adhesive sheet within the above range, it is preferable that the present adhesive sheet does not contain particles such as organic particles.

<Thickness of Present Adhesive Sheet>

The thickness of the present adhesive sheet is not particularly limited. The thickness being 5 μm or more enables the handleability to be good, and the thickness being 1,000 μm or less enables to contribute the laminate to be thinner.

Thus, the thickness of the present adhesive sheet is preferably 5 μm or more, more preferably 8 μm or more, and particularly preferably 10 μm or more. The upper limit thereof is preferably 1,000 μm or less, more preferably 500 μm or less, and particularly preferably 250 μm or less.

[Acrylic Polymer]

The present adhesive sheet contains an acrylic polymer containing a monofunctional (meth)acrylate (a1) and a polyfunctional (meth)acrylate (a2) as monomer components. As long as these monomer components are contained, other components are not particularly limited, and the present adhesive sheet may contain other monomer components and polymer components.

Hereinafter, the acrylic polymer will be described in detail.

<Monofunctional (Meth)Acrylate (a1)>

Examples of the monofunctional acrylate, which is a constituent monomer of the acrylic polymer, include alkyl (meth)acrylate, carboxyl group-containing acrylate, hydroxyl group-containing acrylate, epoxy group-containing acrylate, amino group-containing acrylate, and amide group-containing acrylate.

In the present invention, the monofunctional acrylate is preferably an alkyl (meth)acrylate from the viewpoint of adjusting the glass transition temperature of the acrylic polymer.

Any linear or branched alkyl (meth)acrylate can be adopted as the alkyl (meth)acrylate. Examples thereof include n-butyl (meth)acrylate, isobutyl (meth)acrylate, sec-butyl (meth)acrylate, t-butyl (meth)acrylate, pentyl (meth) acrylate, isopentyl (meth) acrylate, neopentyl (meth)acrylate, hexyl (meth)acrylate, cyclohexyl (meth)acrylate, heptyl (meth)acrylate, 2-ethylhexyl (meth)acrylate, n-octyl (meth)acrylate, isooctyl (meth)acrylate, nonyl (meth)acrylate, isononyl (meth)acrylate, t-butylcyclohexyl (meth) acrylate, decyl (meth)acrylate, isodecyl (meth)acrylate, undecyl (meth)acrylate, lauryl (meth)acrylate, tridecyl (meth)acrylate, tetradecyl (meth)acrylate, cetyl (meth)acrylate, stearyl (meth)acrylate, isostearyl (meth)acrylate, isobornyl (meth)acrylate, 3,5,5-trimethylcyclohexane (meth) acrylate, dicyclopentanyl (meth) acrylate, dicyclopentenyl (meth) acrylate, and dicyclopentenyloxyethyl (meth)acrylate. These may be used singly or in combination of two or more types thereof.

Among these alkyl (meth)acrylates, the monofunctional (meth)acrylate (a1) is preferably an alkyl (meth)acrylate having an alkyl group with 9 to 22 carbon atoms, and more preferably an alkyl (meth)acrylate having an alkyl group with 9 to 18 carbon atoms, from the viewpoint of adjusting the glass transition temperature of the acrylic polymer.

Alkyl (meth)acrylates have different glass transition temperatures of homopolymers depending on the number of carbon atoms of the alkyl group, the presence or absence of branching, and the structure of branching. In order to adjust the average slope to −0.4 to 0.0 kPa/° C., it is preferable to adopt a combination in which the acrylic polymer has a lower glass transition temperature as much as possible. When the number of alkyl carbon atoms is in the range of 9 to 22, it is easy to adjust to a lower glass transition temperature. Alkyl (meth)acrylates having an alkyl group with a branched structure are particularly preferred since they have no crystallinity and have a low glass transition temperature even when the number of carbon atoms is large.

The acrylic polymer contains the monofunctional (meth)acrylate (a1) as a constituent monomer preferably in a content of 70 to 95% by mass, and more preferably in a content of 75 to 90% by mass. When the content is in the above range, it is easy to suppress delamination and cracking of the member sheet at low to high temperatures in the present laminate.

<Polyfunctional (Meth)Acrylate (a2)>

The acrylic polymer preferably contains a polyfunctional (meth)acrylate (a2) as a monomer component, in addition to the monofunctional (meth)acrylate (a1).

By containing the polyfunctional (meth)acrylate (a2) as a monomer component, the present adhesive sheet forms a crosslinked network, and the storage shear elastic modulus can be maintained even at high temperatures to exhibit the adhesive properties.

The type of polyfunctional (meth)acrylate (a2) is not limited as long as it is an acrylate having a plurality of (meth)acrylate groups, but from the viewpoint of facilitating adjustment of the storage shear elastic modulus (G′(80° C.)) of the present adhesive sheet to 100 kPa or less, a polyfunctional urethane (meth) acrylate is preferred.

In order to adjust the average slope to −0.4 to 0.0 kPa/° C., it is necessary to form a crosslinked network such that the storage shear elastic modulus (G′) at high temperatures does not decrease. By selecting a polyfunctional urethane (meth) acrylate as a monomer component in addition to the above-mentioned alkyl (meth)acrylate, an appropriate network can be easily formed. In particular, from the viewpoint of adjusting the storage shear elastic modulus (G′(80° C.)) to 100 kPa or less without excessively increasing the crosslink density, the polyfunctional (meth)acrylate (a2) is more preferably a bi- to tri-functional urethane (meth)acrylate having 2 to 3 (meth)acrylate groups, and particularly preferably a bifunctional urethane (meth) acrylate.

The type of polyfunctional urethane (meth)acrylate is not particularly limited, but is preferably a polyfunctional urethane (meth)acrylate composed of a reaction product of a polyol compound having two or more hydroxyl groups in the molecule, a compound having two or more isocyanate groups in the molecule, and a (meth)acrylate containing one or more hydroxyl groups at least in the molecule.

The weight average molecular weight of the polyfunctional urethane (meth)acrylate is preferably 20,000 to 100,000, more preferably 25,000 to 90,000, and particularly preferably 30,000 to 80,000. When the weight average molecular weight is 20,000 or more, the crosslink density does not become too high, and the storage shear elastic modulus (G′(80° C.)) can be easily adjusted to 100 kPa or less. In addition, when the weight average molecular weight is 100,000 or less, the crosslink density of a certain level or more can be maintained, and the average slope can be easily adjusted to −0.4 to 0.0 kPa/° C.

In the present invention, the weight average molecular weight refers to the polystyrene-equivalent weight average molecular weight measured by gel permeation chromatography.

Examples of the polyol compound having two or more hydroxyl groups in the molecule include polyether polyol, polyester polyol, caprolactone diol, bisphenol polyol, polyisoprene polyol, hydrogenated polyisoprene polyol, polybutadiene polyol, hydrogenated polybutadiene polyol, castor oil polyol, and polycarbonate diol. Among them, polycarbonate diol, polybutadiene polyol, and hydrogenated polybutadiene polyol are preferred since they have excellent transparency and durability; and polycarbonate diol and hydrogenated polybutadiene polyol are particularly preferred from the viewpoint of not causing cloudiness even under high temperature and high humidity conditions. These may be used singly or in combination of two or more types thereof.

Examples of the compound having two or more isocyanate groups in the molecule include aromatic polyisocyanate, alicyclic polyisocyanate, and aliphatic polyisocyanate. Among them, aliphatic polyisocyanate and alicyclic polyisocyanate are preferred from the viewpoint of obtaining a flexible cured product. These may be used singly or in combination of two or more types thereof.

Examples of the aromatic polyisocyanate include 2,4-tolylene diisocyanate, 2,6-tolylene diisocyanate, 1,3-xylylene diisocyanate, 1,4-xylylene diisocyanate, tetramethylxylylene diisocyanate, diphenylmethane diisocyanate, naphthalene-1,5-diisocyanate, and triphenylmethane triisocyanate; examples of the alicyclic polyisocyanate include isophorone diisocyanate, bis(4-isocyanatocyclohexyl) methane, 1,3-bis(isocyanatomethyl) cyclohexane, 1,4-bis(isocyanatomethyl) cyclohexane, norbornane diisocyanate, and bicycloheptane triisocyanate; and examples of the aliphatic polyisocyanate include hexamethylene diisocyanate, 1,3,6-hexamethylene triisocyanate, and 1,6,11-undecatriisocyanate. Among them, diisocyanates such as isophorone diisocyanate and hexamethylene diisocyanate are preferred from the viewpoint of obtaining a cured product not causing cloudiness in the adhesive layer when placed under high temperature and high humidity conditions.

Examples of the (meth)acrylate containing one or more hydroxyl groups at least in the molecule include divalent alcohol mono (meth)acrylates such as ethylene glycol, propylene glycol, 1,3-propanediol, 1,3-butanediol, 1,4-butanediol, and polyethylene glycol; and trivalent alcohol mono (meth)acrylates or di (meth)acrylates such as trimethylolethane, trimethylolpropane, and glycerin. These may be used singly or in combination of two or more types thereof.

The method for synthesizing the polyfunctional urethane (meth)acrylate is not particularly limited, and known methods can be used. For example, the polyol compound having two or more hydroxyl groups in the molecule and the isocyanate compound having two or more isocyanate groups in the molecule are reacted in a diluent (for example, methyl ethyl ketone, methoxyphenol, or the like) in a molar ratio (polyol compound:isocyanate compound) of preferably 3:1 to 1:3, more preferably 2:1 to 1:2, thereby obtaining a urethane prepolymer. Then, the isocyanate group remaining in the obtained urethane prepolymer is reacted with the (meth)acrylate containing one or more hydroxyl groups at least in the molecule in an amount sufficient to react with the isocyanate group, thereby obtaining a polyfunctional urethane (meth)acrylate.

Examples of the catalyst used in this process include lead oleate, tetrabutyltin, antimone trichloride, triphenylaluminum, trioctylaluminum, dibutyltin dilaurate, copper naphthenate, zinc naphthenate, zinc octylate, zinc octatenate, zirconium naphthenate, cobalt naphthenate, tetra-n-butyl-1,3-diacetyloxydistanoxane, triethylamine, 1,4-diaza[2,2,2]bicyclooctane, and N-ethylmorpholin.

The content of the polyfunctional urethane (meth)acrylate (a2) contained as a constituent monomer of the acrylic polymer is preferably 1% to 30% by mass, and more preferably 3% to 20% by mass. Within the above range, it becomes easy to suppress delamination and cracking of the member sheet at low to high temperatures in the present laminate.

The acrylic polymer preferably contains the monofunctional (meth)acrylate (a1) in a content of 70% to 95% by mass and the polyfunctional (meth)acrylate (a2) in a content of 1% to 30% by mass, as monomer components.

<Other Monomer Components>

The acrylic polymer may contain a monomer component other than the above.

For example, in order to improve adhesion to member sheets, it is preferable to contain a monomer having a polar group. Examples of the polar group contained in the monomer include a hydroxyl group, a thiol group, a carboxyl group, a carbonyl group, an ester group, an amino group, an amide group, a glycidyl group, and a silanol group. Among them, a hydroxyl group, an amino group, an amide group, a carbonyl group, an ester group, a glycidyl group, and a silanol group are preferred as polar groups that improve adhesion to members and do not easily corrode peripheral members. Among them, a hydroxyl group, an amino group, an amide group, and a glycidyl group are particularly preferred as those having a high effect on improving adhesion.

Examples of the monomer containing such a polar group include 4-hydroxybutyl acrylate glycidyl ether, 4-hydroxybutyl acrylate, diethyl acrylamide, hydroxyethyl acrylamide, acryloyl morpholine, and 4-t-butyl cyclohexyl acrylate. Among them, 4-hydroxybutyl acrylate, diethyl acrylamide, hydroxyethyl acrylamide, and acryloyl morpholine are particularly preferred from the viewpoint of cost and adhesion.

In addition to the above monofunctional monomers, a bifunctional or higher acrylate may also be contained.

The present adhesive sheet may contain a rust inhibitor in addition to the polymers.

As the type of rust inhibitor, triazoles and benzotriazoles are particularly preferred, and the rust inhibitor prevents transparent electrodes on touch panels from corroding.

The addition amount thereof is preferably 0.01% to 5% by mass, and more preferably 0.1% to 3% by mass, relative to the present adhesive sheet.

The present adhesive sheet may contain a silane coupling agent in addition to the polymers.

As the type of silane coupling agent, those containing a glycidyl group, those having a (meth)acrylic group, and those having a vinyl group are particularly preferred. The inclusion of these agents improves adhesion to member sheets when the adhesive sheet is made into a laminate, and suppresses foaming phenomena in a moist heat environment.

The addition amount thereof is preferably 0.01% to 3% by mass, and more preferably 0.1% to 1% by mass, relative to the present adhesive sheet. Depending on the adherend, the silane coupling agent can be effective even with an addition amount of 0.01% by mass. In addition, foaming due to dealcohol can be suppressed by adjusting the addition amount to 3% by mass or less.

The present adhesive sheet may also contain other additives such as a polymerization initiator, a curing accelerator, a filler, a coupling agent, an ultraviolet absorber, an ultraviolet stabilizer, an antioxidant, a stabilizer, a pigment, and some combination thereof.

The amount of these additives is typically preferably selected so as not to adversely affect the curing of the adhesive sheet or the physical properties of the adhesive sheet.

[Member Sheet]

The present laminate sheet has a structure in which the first member sheet and the above-mentioned adhesive sheet are laminated. The first member sheet preferably has a tensile strength at 25° C., as measured according to ASTM D882, of 10 to 900 MPa.

Also, the present laminate sheet preferably has a structure in which the first member sheet, the present adhesive sheet, and an arbitrary member sheet (referred to as “second member sheet”) are laminated in this order.

In this case, the first member sheet and the second member sheet mean sheets respectively located on both sides of the present adhesive sheet, and there is no individual definitions for the first and second.

Thus, the first member sheet and the second member sheet may be the same or different.

The thickness of the present adhesive sheet is not particularly limited. For example, in the case of being used in an image display device, the present laminate is in the form of a sheet; and the thickness being 0.01 mm or more enables the handleability to be good, and the thickness being 1 mm or less enables to contribute the laminate to be thinner.

Thus, the thickness of the present laminate sheet is preferably 0.01 mm or more, more preferably 0.03 mm or more, and particularly preferably 0.05 mm or more. The upper limit thereof is preferably 1 mm or less, more preferably 0.7 or less, and particularly preferably 0.5 mm or less.

Depending on the configuration of the flexible image display device and the location of the present adhesive sheet, examples of the first member sheet and the second member sheet include a cover lens, a polarizing plate, a retardation film, a barrier film, a touch sensor film, and a light emitting element.

Examples of the material of the first member sheet and the second member sheet include polyimide, polycarbonate, acrylic polymer, TAC, polyester, and cyclic olefin polymer.

In particular, considering the configuration of the image display, the first member sheet preferably has a touch input function. In the case where the present adhesive sheet has the above-mentioned second member sheet, the second member sheet may also have a touch input function.

The tensile strength at 25° C., as measured according to ASTM D882, of the first member sheet is preferably 10 to 900 MPa, more preferably 15 MPa or more or 800 MPa or less, and even more preferably 20 MPa or more or 700 MPa or less.

In the case where the present adhesive sheet has the above-mentioned second member sheet, the tensile strength at 25° C., as measured according to ASTM D882, of the second member sheet is preferably 10 to 900 MPa, more preferably 15 MPa or more or 800 MPa or less, and even more preferably 20 MPa or more or 700 MPa or less.

Examples of the member sheet having high tensile strength include a polyimide film and a polyester film, and these tensile strengths are generally 900 MPa or less.

Examples of the member sheet having slightly lower tensile strength include a TAC film and a cyclic olefin polymer (COP) film, and these tensile strengths are 10 MPa or more. The present laminate sheet is able to suppress defects such as cracking even when the member sheet is made of such a material having slightly lower tensile strength.

[Method for Producing Present Laminate Sheet]

Next, a method for producing the present laminate sheet will be described. However, the following description is an example of methods for producing the present laminate sheet, and the present laminate sheet is not limited to that produced by such a method.

As for the production of the present laminate sheet, the present adhesive sheet may be produced by: for example, preparing a resin composition for the present adhesive sheet containing an acrylic monomer and optionally an acrylic polymer, an olefin-based monomer, an olefin-based polymer, a tackifier, a polymerization initiator, and other components; forming the resin composition into a sheet; curing the acrylic monomer by crosslinking, that is, by polymerizing; and optionally performing appropriately processing. However, it is not limited to this method.

Then, the present adhesive sheet can be bonded to a first member sheet and a second member sheet, thereby producing the present laminate sheet. However, it is not limited to such a production method.

When preparing the resin composition for the present adhesive sheet, the above raw materials may be kneaded using a temperature-controllable kneader (for example, uniaxial extruder, biaxial extruder, planetary mixer, biaxial mixer, pressure kneader, or the like).

When mixing various raw materials, various additives such as a silane coupling agent and an antioxidant may be blended with the resin in advance and then supplied to the kneader, or all the materials may be melt-mixed in advance and then supplied, or a master batch in which only the additives are concentrated in the resin in advance may be prepared and then supplied.

In order to impart curability to the present adhesive sheet, it is preferable to polymerize, or in other words, to crosslink the resin composition for the present adhesive sheet as described above.

In this case, the resin composition for the present adhesive sheet may be coated on the first or second member sheet and then polymerized, or the resin composition for the present adhesive sheet may be polymerized and then bonded.

To polymerize the resin composition for the present adhesive sheet, the resin composition for the present adhesive sheet preferably contains a polymerization initiator.

The type of polymerization initiator is not particularly limited as long as it is a polymerization initiator that can be used in the polymerization reaction. For example, those activated by heat and those activated by active energy rays can be used. In addition, those that generate radicals and cause radical reactions, and those that generate cations and anions and cause addition reactions can also be used.

The polymerization initiator is preferably a photopolymerization initiator, and the selection of photopolymerization initiator generally depends, at least in part, on the specific components used in the curable composition and the desired curing speed.

Examples of the photopolymerization initiator include acetophenone, benzoin, benzophenone, benzoyl compounds, anthraquinone, thioxanthone, phosphine oxides, such as phenyl and diphenylphosphine oxides, ketones, and acridine.

Specifically, photopolymerization initiators, available under the trade names DAROCUR (Ciba Specialty Chemicals), IRGACURE (Ciba Specialty Chemicals), and LUCIRIN (BASF) such as ethyl-2,4,6-trimethylbenzoyl diphenylphosphinate available as LUCIRIN TPO, can be cited.

Photopolymerization initiators having an excitation wavelength range of 400 nm or more can also be selected for use. Specific examples of the photopolymerization initiator include α-diketones such as camphorquinone and 1-phenyl-1,2-propanedione; acylphosphine oxides such as 2,4,6-trimethylbenzoyldiphenylphosphine oxide and bis(2,4,6-trimethylbenzoyl)-phenylphosphine oxide; α-amino alkylphenones such as 2-benzyl-2-dimethylamino-1-(4-morpholinophenyl)-butanone-1 and 2-methyl-1-(4-methylthiophenyl)-2-morpholinopropan-1-one; and titanocenes such as bis(η₅-2,4-cyclopentadien-1-yl)-bis(2,6-difluoro-3-(1H-pyrrol-1-yl)phenyl)titanium. Among them, from the viewpoint of good polymerization activity and less harmful to living organisms, α-diketones and acylphosphine oxides are preferred, and camphorquinone and 2,4,6-trimethylbenzoyldiphenylphosphine oxide are more preferred.

Meanwhile, thermal polymerization initiators can be used for polymerization in addition to the photopolymerization initiators.

Examples of the thermal polymerization initiators include azo compounds, quinines, nitro compounds, acyl halides, hydrazones, mercapto compounds, pyrylium compounds, imidazoles, chlorotriazines, benzoin, benzoin alkyl ethers, diketones, phenones, dilauroyl peroxides, and organic peroxides such as 1,1-di(t-hexylperoxy)-3,3,5-trimethylcyclohexane, available as PERHEXA™ H (NOF Corp.).

The polymerization initiators are often used at a concentration of approximately 0.01% by mass to approximately 10% by mass, or approximately 0.01% by mass to approximately 5% by mass, based on the total mass of the curable composition. A mixture of the polymerization initiators may be used.

Examples of the method for molding the resin composition for the adhesive sheet into a sheet shape include known methods, such as a wet laminating method, a dry laminating method, an extrusion casting method using a T-die, an extrusion laminating method, a calender method, an inflation method, an injection molding method, and a liquid injection curing method. Among them, a wet laminating method, an extrusion casting method, and an extrusion laminating method are preferred for producing sheets.

When the resin composition for the adhesive sheet contains a polymerization initiator, a cured product can be produced by irradiating the resin composition with heat and/or active energy rays for curing. In particular, the present adhesive sheet can be produced by irradiating a molded resin composition for the present adhesive sheet with heat and/or active energy rays.

Examples of the active energy rays to be irradiated include ionizing radiation such as α-rays, β-rays, γ-rays, neutron rays, and electron beams; ultraviolet rays; and visible light. Among them, ultraviolet rays are preferred from the viewpoint of suppressing damage to optical device constituent members and of the reaction control.

The irradiation energy, irradiation time, and irradiation method of the active energy rays are not particularly limited as long as the monomer component can be polymerized by activating the polymerization initiator.

As another embodiment of the method for producing the present adhesive sheet, the resin composition for the present adhesive sheet, which will be described later, may be dissolved in an appropriate solvent, and various coating methods may be used.

In the case of using the coating methods, the present adhesive sheet can also be obtained by heat curing, in addition to the above-mentioned active energy ray irradiation curing.

In the case of using the coating methods, the thickness of the adhesive sheet can be adjusted by the coating thickness and the solid content concentration of the coating liquid.

From the viewpoint of preventing blocking and foreign material adhesion, a protective film on which a release layer is laminated can be provided on at least one surface of the present adhesive sheet.

Alternatively, embossing and various kinds of unevenness (cone shape, pyramid shape, hemispherical shape, and the like) processing may be performed as necessary. In addition, for the purpose of improving adhesion to various member sheets, various surface treatments such as a corona treatment, a plasma treatment, and a primer treatment may be performed on the surface.

[Image Display Device]

By incorporating the present laminate sheet, for example, by laminating the present laminate sheet on other image display device constituent members, an image display device including the present laminate sheet can be formed.

In particular, the present laminate sheet prevents delamination and cracking of the laminate sheet even when the laminate sheet is folded under low and high temperature environments, and has good restorability, thereby capable of forming a flexible image display device.

Examples of the other image display device constituent members include optical films such as a polarizing film and a retardation film, liquid crystal materials, and backlight panels.

[Explanation of Terms and Phrases]

According to the definition of Japanese Industrial Standard (JIS), a “sheet” is generally a thin and flat product having a thickness that is smaller than the length and the width thereof, and a “film” is generally a product having a thickness that is extremely smaller than the length and the width thereof, and having a maximum thickness that is arbitrarily determined, which is generally supplied in the form of a roll (Japanese Industrial Standard, JIS K6900). However, there is no definite boundary between the sheet and the film, and there is no need of literally distinguishing these terms. In the present invention, accordingly, the case referred to as a “film” is assumed to include a “sheet”, and the case referred to as a “sheet” is assumed to include a “film”.

In addition, in the case of being expressed as the “panel” such as an image display panel and a protective panel, it is assumed to include a plate body, a sheet, and a film.

In the case of being described as the phrase “X to Y” (X and Y are arbitrary numbers) in the present specification, the phrase includes the meaning of “preferably more than X” or “preferably less than Y” along with the meaning “X or more and Y or less”, unless otherwise stated.

Also, the phrase “X or more” (wherein X represents an arbitrary numeral) or “Y or less” (wherein Y represents an arbitrary numeral) includes the meaning “preferably more than X” or “preferably less than Y”, unless otherwise stated.

The present invention will be further described with reference to Examples below. The present invention is not limited to the following Examples.

[Preparation of Adhesive Sheet]

An adhesive sheet laminate in each of Examples 1 to 4 and Comparative Examples 1 to 2 was prepared as follows.

A resin composition was prepared by blending raw materials in the mass ratio shown in Table 1, and the resin composition was applied in a sheet form on a silicone release-treated release film (PET film, manufactured by Mitsubishi Chemical Corp.) having a thickness of 100 μm such that the thickness of the resin composition was 25 μm.

Next, a silicone release-treated release film (PET film, manufactured by Mitsubishi Chemical Corp.) having a thickness of 75 μm was laminated on the sheet-shaped resin composition to form a laminate; and the laminate was irradiated with light using a metal halide lamp irradiator (UVC-0516S1, lamp: UVL-8001M3-N, manufactured by Ushio Inc.) such that the irradiation amount at a wavelength of 365 nm was 2,000 mJ/cm², thereby preparing an adhesive sheet laminate having the release films respectively laminated on both front and back sides of the adhesive sheet (sample) having a thickness of 25 μm.

The details of the raw materials used for preparing the adhesive sheet were as follows.

### <Monomer Components of Acrylic Polymer>

### 1. Monofunctional (Meth)Acrylate (a1)

(1) NK Ester S1800ALC;

Isostearyl acrylate having an alkyl group with 18 carbon atoms (branched), manufactured by Shin Nakamura Chemical Co., Ltd.

(2) INAA;

Isononyl acrylate branched isomer mixture having an alkyl group with 9 carbon atoms (branched), manufactured by Osaka Organic Chemical Industry Ltd.

(3) IDAA;

Isodecyl acrylate having an alkyl group with 10 carbon atoms (branched), manufactured by Osaka Organic Chemical Industry Ltd.

### 2. Polyfunctional (Meth)Acrylate (a2)

(1) CN9014NS; Bifunctional urethane acrylate of hydrogenated polybutadiene, manufactured by SARTMER

(2) UV-36301D80;

Hydrogenated polybutadiene-based urethane acrylate, manufactured by Nippon Synthetic Chemical Industry Co., Ltd.

### 3. Other Monomers

(1) DEAA;

Diethyl acrylamide, manufactured by KJ Chemicals Corp.

<Other Components>

### 1. Photopolymerization Initiator

(1) Omnirad TPO-G;

Acylphosphine oxide-based photopolymerization initiator, manufactured by BASF

### 2. Acrylic Polymer

(1) Panlon S-2012 Solid Component;

Polymer containing 2-ethylhexyl acrylate (C8) and butyl acrylate (C4) as main components, having a weight average molecular weight (Mw) of 840,000 and Mw/Mn of 3.3, manufactured by Negami Chemical Industrial Co., Ltd. (the product was commercially available in the state of being diluted with toluene, but the toluene was volatilized to recover only the solid component.)

### 3. Isoparaffin

(1) IP Solvent 2835;

Isoparaffin, manufactured by Idemitsu Kosan Co., Ltd.

TABLE 1

| | | | | Example | Example | Example | Example | Comparative | Comparative |
|---|---|---|---|---|---|---|---|---|---|
| | | | | 1 | 2 | 3 | 4 | Example 1 | Example 2 |
| Acrylic | Monofunctional | NK Ester S1800ALC | Mass | | | 78.0 | | | |
| polymer | (meth)acrylate (a1) | INAA | ratio | 90.0 | | | | | |
| | | IDAA | | | 90.0 | | 90.9 | 50.0 | 100.0 |
| | Polyfunctional | CN9014NS | | 10.0 | 7.0 | 16.0 | 9.1 | 5.6 | |
| | (meth)acrylate (a2) | UV-3630ID80 | | | | | | 44.4 | |
| | Other monomers | DEAA | | | 3.0 | 6.0 | | | |
| | Polymer total | | | 100.0 | 100.0 | 100.0 | 100.0 | 100.0 | 100.0 |
| Other | Photopolymerization | Omnirad TPO-G | | 1.7 | 1.7 | 1.7 | 1.7 | 1.7 | 1.7 |
| components | initiator | | | | | | | | |
| | Acrylic polymer | Panlon S-2012 | | | | | 36.4 | | |
| | | (solid component) | | | | | | | |
| | lsoparaffin | IP Solvent 2835 | | | | 83.3 | | | |

[Evaluations of Adhesive Sheet]

The adhesive sheet (sample) prepared in each of Examples and Comparative Examples was evaluated as follows.

<Storage Shear Elastic Modulus (G′), Average Slope, and Loss Tangent (tan δ)>

The release films were removed from the laminate prepared in each of Examples and Comparative Examples, and the remaining sheet was laminated to obtain an adhesive sheet (sample) having a thickness of approximately 2 mm.

The obtained adhesive sheet (sample) was used as a sample (circular shape with a thickness of approximately 2 mm and a diameter of 20 mm), and the storage shear elastic modulus (G′) and the loss tangent (tan δ) were measured using a rheometer (“MARS” manufactured by Eko Instruments Co., Ltd.) under the following measurement conditions.

From the obtained data, the temperature at which the maximum point of the loss tangent (tan δ) appears (glass transition temperature (Tg)), the storage shear elastic modulus at −20° C. (G′(−20° C.)), and the storage shear elastic modulus at 80° C. (G′(80° C.)) were determined. In addition, the average slope (kPa/° C.) was calculated from the following formula.

Average slope=(G′(80° C.)−G′(−20° C.))/100 (1)

(Measurement Conditions of Storage Shear Elastic Modulus G′)
Adhesive jig: 020 mm parallel plate
Strain: 0.1%
Frequency: 1 Hz
Measurement temperature: −70° C. to 100° C.
Temperature rise rate: 3° C./min

[Preparation of Laminate Sheet]

Next, the release films of the prepared adhesive sheet laminate were removed, and then first and second member sheets were respectively bonded to both sides of the adhesive sheet (sample) by hand rolling, thereby preparing a laminate sheet (sample).

In Examples 1 to 4 and Comparative Examples 1 to 2, a polyimide film (product name: UPILEX 50S, thickness: 50 μm, tensile strength at 25° C.: 455 MPa, manufactured by Ube Industries, Ltd.) was used for the first and second member sheets.

[Evaluations of Laminate Sheet]

The laminate sheet (sample) prepared in each of Examples and Comparative Examples was evaluated as follows.

(Dynamic Folding)

The prepared laminate sheet (sample) was subjected to cyclic evaluation of U-shaped bending with the COP film side inside, using an endurance system in a thermo-hygrostat and a planar body unloaded U-shaped stretching tester (manufactured by Yuasa System Co., Ltd.) with a radius of curvature R of 3 mm and 60 rpm (1 Hz).

It was evaluated at a temperature of −30° C. and 100,000 cycles. The following evaluation criteria were used.

◯: No delamination, cracking, buckling, or flowing of the bent portion occurred.

x: Any of delamination, cracking, buckling, or flowing of the bent portion occurred.

(Static Folding)

The prepared laminate sheet (sample) was bent with the COP film side inside at a radius of curvature R of 3 mm, stored for 24 hours under the conditions of 85° C. and 85% RH, and then restored by opening the jig to evaluate the restorability after 1 hour. Similarly, the restorability of only the member sheet (UPILEX 50S) was confirmed, and the inner angle of the film was 90°.

◯: It was restored to an inner angle of 70° or more and 90° or less at the bent portion.

x: The inner angle of the bent portion was less than 70°, or any of delamination, cracking, buckling, or flowing was observed.

The evaluation results of the adhesive sheet (sample) and the laminate sheet (sample) are shown in Table 2.

TABLE 2

| | | Example | Example | Example | Example | Comparative | Comparative |
|---|---|---|---|---|---|---|---|
| | | 1 | 2 | 3 | 4 | Example 1 | Example 2 |
| Storage shear elastic modulus G' (−20° C.) | kPa | 58.3 | 69.5 | 18.4 | 50.5 | 455.0 | 94.5 |
| Storage shear elastic modulus G' (80° C.) | | 21.4 | 29.6 | 9.7 | 12.3 | 32.0 | 1.4 |
| Temperature at which the maximum point of the loss | ° C. | −36 | −31 | −20 | −32 | −14 | −34 |
| tangent (tan δ) appears | | | | | | | |
| tan δ (80° C.) | | 0.09 | 0.01 | 0.08 | 0.19 | 0.12 | 0.61 |
| Average slope | kPa/° C. | −0.37 | −0.40 | −0.09 | −0.38 | −4.23 | −0.93 |
| Dynamic folding | | ◯ | ◯ | ◯ | ◯ | x (cracking) | ◯ |
| Static folding | | ◯ | ◯ | ◯ | ◯ | x (delamination) | x (delamination |
| | | | | | | | and flowing) |

In Examples 1 to 4, the average slope was between −0.4 and 0 kPa/° C., and both the low temperature (−30° C.) dynamic test and the high temperature (85° C., 85% RH) static test could be passed.

In Comparative Examples 1 and 2, the average slope was large, both the low temperature dynamic test and the high temperature static test could not be passed, and the foldable performance was insufficient.

1. An adhesive sheet, satisfying the following requirements (1) to (3):
(1) the storage shear elastic modulus at 80° C. (G′(80° C.)) obtained by dynamic viscoelasticity measurement in a shear mode at a frequency of 1 Hz is 1.0 kPa or more and 100 kPa or less;
(2) the storage shear elastic modulus at −20° C. (G′(−20° C.)) obtained by dynamic viscoelasticity measurement in a shear mode at a frequency of 1 Hz is 1.0 kPa or more and 140 kPa or less; and
(3) when the storage shear elastic modulus is measured by dynamic viscoelasticity measurement in a shear mode at a frequency of 1 Hz, the average slope of −20° C. to 80° C. is −0.40 to 0 (kPa/° C.) on a graph where the y-axis represents the storage shear elastic modulus (kPa) and the x-axis represents the temperature (° C.), the average slope being represented by formula (1): average slope=(G′(80° C.)−G′(−20° C.))/100.

2. The adhesive sheet according to claim 1, wherein the adhesive sheet comprises an acrylic polymer containing a monofunctional (meth)acrylate (a1) and a polyfunctional (meth)acrylate (a2) as monomer components.

3. The adhesive sheet according to claim 2, wherein the monofunctional (meth)acrylate (a1) comprises an alkyl (meth)acrylate having an alkyl group with 9 to 22 carbon atoms.

4. The adhesive sheet according to claim 2, wherein the monofunctional (meth)acrylate (a1) comprises an alkyl (meth)acrylate having an alkyl group with a branched structure.

5. The adhesive sheet according to claim 2, wherein the polyfunctional (meth)acrylate (a2) comprises a polyfunctional urethane (meth)acrylate.

6. The adhesive sheet according to claim 5, wherein the polyfunctional (meth)acrylate (a2) comprises a bifunctional urethane (meth)acrylate.

7. The adhesive sheet according to claim 2, wherein the acrylic polymer contains the monofunctional (meth)acrylate (a1) in a content of 70% to 95% by mass and the polyfunctional (meth)acrylate (a2) in a content of 1% to 30% by mass, as monomer components.

8. The adhesive sheet according to claim 1, wherein the adhesive sheet has a loss tangent at 80° C. (tan δ (80° C.)) in a shear measurement at a frequency of 1 Hz of 0.60 or less.

9. The adhesive sheet according to claim 1, wherein the adhesive sheet has a maximum point of a loss tangent obtained by dynamic viscoelasticity measurement in a shear mode at a frequency of 1 Hz of −25° C. or less.

10. A laminate sheet, comprising a structure in which a first member sheet satisfying the following requirement (4) and the adhesive sheet according to claim 1 are laminated:
(4) the tensile strength at 25° C., as measured according to ASTM D882, is 10 to 900 MPa.

11. The laminate sheet according to claim 10, having a structure in which the first member sheet, the adhesive sheet, and a second member sheet are laminated in this order.

12. The laminate sheet according to claim 10, wherein the first member sheet has a touch input function.

13. An image display device, comprising the laminate sheet according to claim 12.
